(19) United States
(12) Patent Application Publication
(10) Pub. No.: US 2013/0289794 A1
(43) Pub. Date: Oct. 31, 2013

(54) SERVER ASSEMBLY

(71) Applicant: HON HAI PRECISION INDUSTRY CO., LTD., New Taipei (TW)

(72) Inventor: FENG-CHI YANG, New Taipei (TW)

(73) Assignee: HON HAI PRECISION INDUSTRY CO., LTD., New Taipei (TW)

(21) Appl. No.: 13/855,390

(22) Filed: Apr. 2, 2013

(30) Foreign Application Priority Data
Apr. 28, 2012 (CN) 201210129495.9

(51) Int. Cl. G06F 1/20

(52) U.S. Cl. CPC G06F 1/206
USPC 700/300

(57) ABSTRACT

A server assembly includes a rack, at least one server slidably received in the rack, a fan attached to the rack, a control unit, at least one trigger unit corresponding to the at least one server, and a display unit. When the at least one server is positioned at a desired location in the rack, the at least one server triggers the at least one trigger unit to send at least one trigger signal to the control unit. The control unit receives the at least one trigger signal and controls the display unit to display a notice about whether the at least one server is positioned in the desired location.

### BACKGROUND

1. Technical field

The disclosure generally relates to server assemblies.

2. Description of the Related Art

Typical server assemblies include a rack, a plurality of servers, and fans for dissipating heat produced by the servers. The plurality of servers stack in desired locations in the rack, the fans direct cold airflow to air channels defined between the plurality of servers.

However, if the plurality of servers are not located in the desired locations, then the size of the space between the plurality of servers are changed, and the air channels are changed. Thus, the heat dissipation of the server assembly may be poor.

Therefore, there is room for improvement within the art.

### BRIEF DESCRIPTION OF THE DRAWINGS

Many aspects of an exemplary server assembly can be better understood with reference to the following drawings. The components in the drawings are not necessarily drawn to scale, the emphasis instead being placed upon clearly illustrating the principles of the exemplary server assembly. Moreover, in the drawings, like reference numerals designate corresponding parts throughout the several views. Wherever possible, the same reference numbers are used throughout the drawings to refer to the same or like elements of an embodiment.

FIG. 1 is a schematic view illustrating a server assembly during assembly, according to an exemplary embodiment.

FIG. 2 is an assembled, schematic view of the server assembly shown in FIG. 1.

FIG. 3 is a block diagram of the server assembly shown in FIG. 1.

### DETAILED DESCRIPTION

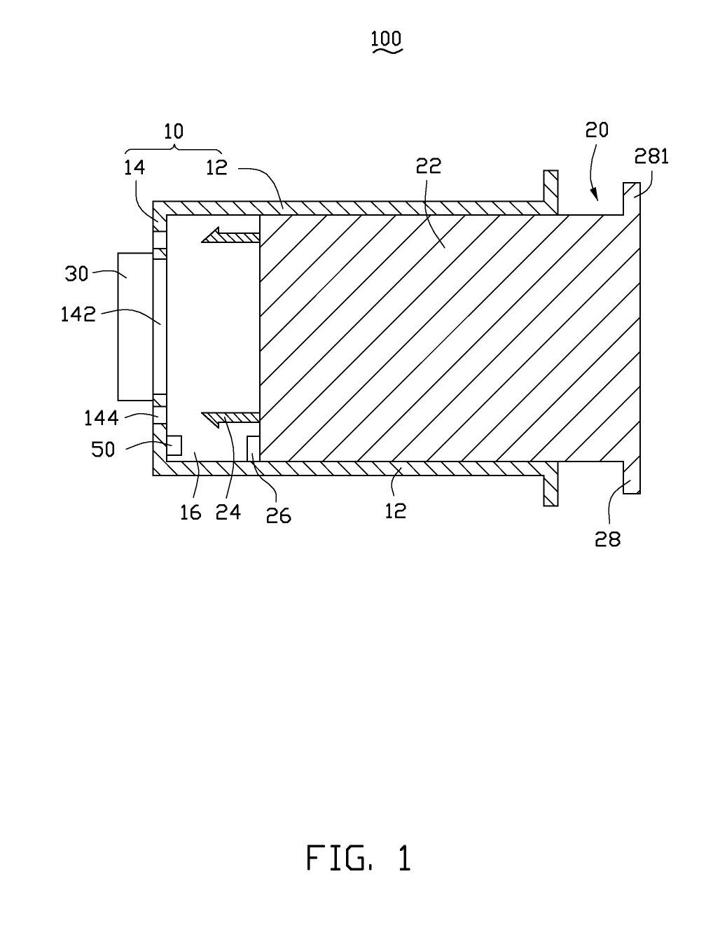

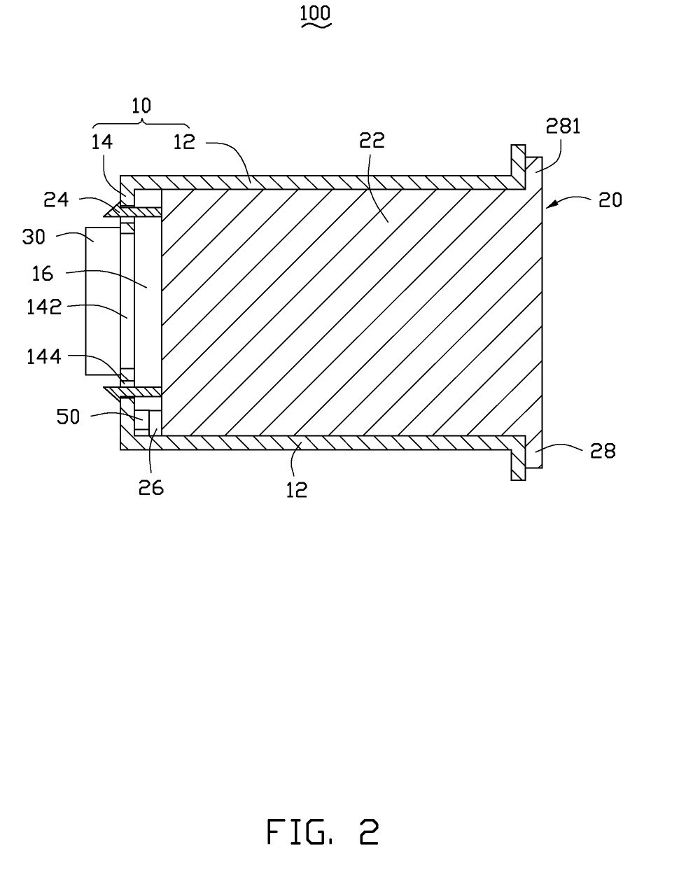

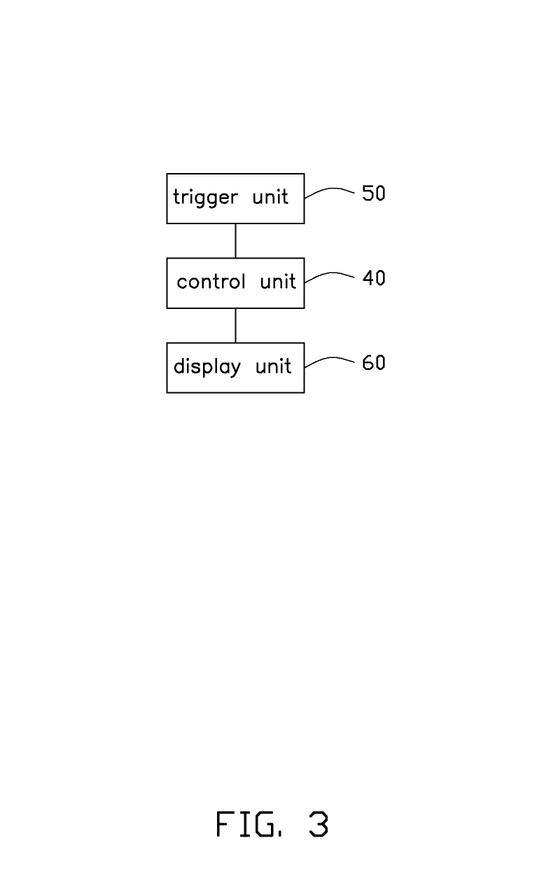

FIG. 1, FIG. 2 and FIG. 3 show an exemplary embodiment of a server assembly 100. The server assembly 100 includes a rack 10, a plurality of servers 20 stacked in the rack 10, a fan 30 attached to the rack 10, a control unit 40 (only shown schematically), a plurality of trigger units 50, and a display unit 60 (also, only shown schematically). The trigger units 50 send trigger signals to the control unit 40, and the control unit 40 allows the display unit 60 to display notices according to the trigger signals. To describe the server assembly 100 clearly, FIG. 1 only shows one server 20 and one trigger unit 50.

The rack 10 includes two opposite sidewalls 12 and an end wall 14. The two sidewalls 12 and the end wall 14 enclose a cavity 16 together. The end wall 14 defines an opening 142 and two locking holes 144. The opening 142 is located between the two locking holes 144. The fan 30 is located on the end wall 14 and is opposite to the opening 142.

The trigger unit 50 is located in the cavity 16 and is mounted to the end wall 14. Each trigger unit 50 corresponds to one server 20. In this embodiment, the trigger unit 50 is a switch made of metal.

The server 20 includes a main body 22, two clasp portions 24, a protrusion 26, and a resisting plate 28. The two clasp portions 24 and the protrusion 26 are located at a same side of the main body 22, and the resisting plate 28 away from the clasp portions 24 is located at an opposite side of the main body 22. The main body 22 is slidably received in the cavity 16. The two clasp portions 24 are engaged with the two locking holes 144 to fix the main body 22 to the rack 10. The protrusion 26 is configured for resisting the trigger unit 50 to enable the trigger unit 50 to send trigger signals to the control unit 40. The resisting plate 28 is wider than the main body 22 and forms a flange portion 281. The flange portion 281 is configured for resisting the sidewalls 12 to prevent the main body 22 from sliding.

When the two clasp portions 24 are respectively received in the two locking holes 144, the server 20 is positioned in a desired location. Meanwhile, the protrusion 26 contacts the trigger unit 50 to send a trigger signal to the control unit 40. The control unit 40 receives the trigger signal and controls the display unit 60 to display a notice, such as “in desired location.”

As detailed above, a user can check whether the server 20 is positioned in a desired location by the display unit 60. Each server 20 may be positioned in a desired location and air channels defined between the plurality of servers 20 will not be changed.

In another exemplary embodiment, the trigger unit 50 is an infrared sensor.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A server assembly, comprising:
a rack;
at least one server slidably received in the rack;
a fan attached to the rack;
a control unit;
at least one trigger unit corresponding to the at least one server; and
a display unit;
wherein when the at least one server is positioned at a desired location in the rack, the at least one server triggers the at least one trigger unit to send at least one trigger signal to the control unit; the control unit receives the at least one trigger signal and controls the display unit to display a notice about whether the at least one server is positioned in the desired location.

2. The server assembly as claimed in claim 1, wherein the rack comprises two opposite sidewalls and an end wall, the two sidewalls and the end wall enclose a cavity together; the at least one server is slidably received in the cavity.

3. The server assembly as claimed in claim 2, wherein the end wall defines an opening, the fan is located on the end wall and is opposite to the opening.

4. The server assembly as claimed in claim 2, wherein the end wall defines two locking holes; the server comprises two clasp portions; the two clasp portions are respectively received in the two locking holes.

5. The server assembly as claimed in claim 4, wherein the server further comprises a protrusion, the trigger unit is located in the cavity and is mounted to the end wall, when the two clasp portions are respectively received in the two locking holes, the protrusion contacts the trigger unit to trigger the trigger unit.

6. The server assembly as claimed in claim 5, wherein the trigger unit is a switch.

7. The server assembly as claimed in claim 6, wherein the trigger unit is made of metal.

8. The server assembly as claimed in claim 1, wherein the trigger unit is an infrared sensor.

9. The server assembly as claimed in claim 4, wherein the server further comprises a resisting plate away from the clasp portions, the resisting plate forms a flange portion configured for resisting the sidewalls to prevent the server from sliding.

10. A server assembly, comprising:
a rack;
at least one server slidably received in the rack;
a control unit;
at least one trigger unit corresponding to the at least one server; and
a display unit;
wherein when the at least one server is positioned at a desired location in the rack, the at least one server triggers the at least one trigger unit to send at least one trigger signal to the control unit; the control unit receives the at least one trigger signal and controls the display unit to display a notice about whether the at least one server is positioned in the desired location.

11. The server assembly as claimed in claim 10, wherein the rack comprises two opposite sidewalls and an end wall, the two sidewalls and the end wall enclose a cavity together; the at least one server is slidably received in the cavity.

12. The server assembly as claimed in claim 11, wherein the end wall defines an opening, a fan is located on the end wall and is opposite to the opening.

13. The server assembly as claimed in claim 11, wherein the end wall defines two locking holes; the server comprises two clasp portions; the two clasp portions are respectively received in the two locking holes.

14. The server assembly as claimed in claim 13, wherein the server further comprises a protrusion, the trigger unit is located in the cavity and is mounted to the end wall, when the two clasp portions are respectively received in the two locking holes, the protrusion contacts the trigger unit to trigger the trigger unit.

15. The server assembly as claimed in claim 14, wherein the trigger unit is a switch.

16. The server assembly as claimed in claim 15, wherein the trigger unit is made of metal.

17. The server assembly as claimed in claim 10, wherein the trigger unit is an infrared sensor.

18. The server assembly as claimed in claim 13, wherein the server further comprises a resisting plate away from the clasp portions, the resisting plate forms a flange portion configured for resisting the sidewalls to prevent the server from sliding.
